(19) United States
(12) Patent Application Publication
(10) Pub. No.: US 2006/0028127 A1
(43) Pub. Date: Feb. 9, 2006

(54) Organic electro-luminescent device and method for fabricating the same

(75) Inventors: Shi-Hao Li, Banciao City (TW); Fan-Hsiu Chang, Miaoli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/028,088

(22) Filed: Jan. 3, 2005

(30) Foreign Application Priority Data
Aug. 6, 2004 (TW) 93123601

(51) Int. Cl. H05B 33/00

(52) U.S. Cl. 313/506; 313/504

(57) ABSTRACT

An organic electro-luminescent device with an optical compensation layer comprising a substrate comprising a first device region and a second device region, a first diode, and a second diode. The first diode is disposed in the first device region and the second diode in the second device region. Each diode comprises an anode, an opposing transparent cathode, and an organic electro-luminescent medium layer sandwiched therebetween. The transparent cathode in the first device region has a thickness substantially equal to that in the second device region. An optical layer is adjacent to the transparent cathode in the first device region, serving as the optical compensation layer to form cathodes with different thicknesses in first and second device regions, respectively. Methods for fabricating an organic electro-luminescent device are also disclosed.

### BACKGROUND

The invention relates to an electro-luminescent (EL) device and in particular to an organic electro-luminescent diode (OELD) with an optical compensation layer to form cathodes with different thicknesses and methods for fabricating the same.

Organic electro-luminescent diodes are active lighting devices using organic materials. Compared with conventional inorganic LEDs, OELDs can be easily fabricated on a large substrate by forming an amorphous silicon layer thereon. Additionally, displays utilizing OELDs require no backlight module, such that the manufacturing process is simpler and costs are reduced. OELD technology is highly developed and can be employed in small panels such as those in personal digital assistants (PDAs) or digital cameras.

OELDs typically comprise an anode, a cathode, and an organic electro-luminescent medium layer disposed therebetween. The electro-luminescent medium layer typically comprises a hole transport layer adjacent to the anode, an electron transport layer adjacent to the cathode, and a light-emitting layer sandwiched therebetween. When an electrical potential difference is applied between the anode and the cathode, electrons are injected into the electron transport layer from the cathode and then pass through the electron transport layer and the light-emitting layer. At the same time, holes are injected into the hole transport layer from the anode and then pass therethrough. The injected electrons and holes are recombined at the interface of the light-emitting layer and the hole transport layer, releasing energy as light.

Since the wavelength difference between blue light and red light is larger than that between blue light and green light or red light and green light, cathodes with different thicknesses are required to provide red and blue light with high color purity and improve current efficiency. Typically, the transparent cathode is an indium tin oxide or indium zinc oxide layer formed by sputtering. In order to fabricate cathodes of different thicknesses, a metal mask is employed to form transparent cathodes for red, green, and blue light OELDs. The temperature of the metal mask, however, is increased due to ion bombardment during sputtering. As a result, the metal mask is easily deformed and it is difficult to form cathodes with different thicknesses.

### SUMMARY

Organic electro-luminescent devices and methods for fabricating the same are provided. An embodiment of an organic electro-luminescent device comprises a substrate comprising a first device region and a second device region, a first anode and an opposing first transparent cathode, a first organic electro-luminescent medium layer, a first optical layer, a second anode and an opposing second transparent cathode, and a second organic electro-luminescent medium layer. The first anode and the first transparent cathode are disposed in the first device region. The first organic electro-luminescent medium layer is sandwiched between the first anode and the first transparent cathode. The first optical layer is disposed on the first transparent cathode. The second anode and the second transparent cathode are disposed in the second device region. The second organic electro-luminescent medium layer is sandwiched between the second anode and the second transparent cathode. The first transparent cathode has a thickness substantially equal to the second transparent cathode.

An embodiment of a method for fabricating an organic electro-luminescent device comprises providing a substrate comprising a first device region and a second device region. An anode is respectively formed in the first and second device regions. An organic electro-luminescent medium layer is formed on each anode. A transparent cathode is formed on each organic electro-luminescent medium layer. An optical layer is formed on the transparent cathode in the first device region.

An embodiment of an organic electro-luminescent device comprises a substrate comprising a first device region and a second device region, a first anode and an opposing first transparent cathode, a first organic electro-luminescent medium layer, a first optical layer, a second anode and an opposing second transparent cathode, and a second organic electro-luminescent medium layer. The first anode and the first transparent cathode are disposed in the first device region. The first organic electro-luminescent medium layer is sandwiched between the first anode and the first transparent cathode. The first optical layer is sandwiched between the first transparent cathode and the first organic electro-luminescent medium layer. The second anode and the second transparent cathode are disposed in the second device region. The second organic electro-luminescent medium layer is sandwiched between the second anode and the second transparent cathode. The first transparent cathode has a thickness substantially equal to the second transparent cathode.

An embodiment of a method for fabricating an organic electro-luminescent device comprises providing a substrate comprising a first device region and a second device region. An anode is respectively formed in the first and second device regions. An organic electro-luminescent medium layer is formed on each anode. An optical layer is formed on the organic electro-luminescent medium layer in the first device region. A transparent cathode is respectively formed on the optical layer in the first device region and on the organic electro-luminescent medium layer in the second device region.

### DESCRIPTION OF THE DRAWINGS

Organic electro-luminescent devices and methods for fabricating the same will become more fully understood from the detailed description given hereinbelow and the accompanying drawings, given by way of illustration only and thus not intended to be limitative of the invention.

FIG. 1 is a cross-section of an embodiment of an organic electro-luminescent device with an optical compensation layer.

FIG. 2 is a cross-section of an embodiment of an organic electro-luminescent device with an optical compensation layer.

FIG. 3 is a cross-section of an embodiment of an organic electro-luminescent device with an optical compensation layer.

FIG. 4 is a cross-section of an embodiment of an organic electro-luminescent device with an optical compensation layer.

FIG. 5 is a graph showing the relationship between the current density and the driving voltage for an organic electro-luminescent diode.

FIG. 6 is a graph showing the relationship between the brightness and the driving voltage for an organic electro-luminescent diode.

FIG. 7 is a graph showing the relationship between the current efficiency and the driving voltage for an organic electro-luminescent diode.

### DETAILED DESCRIPTION

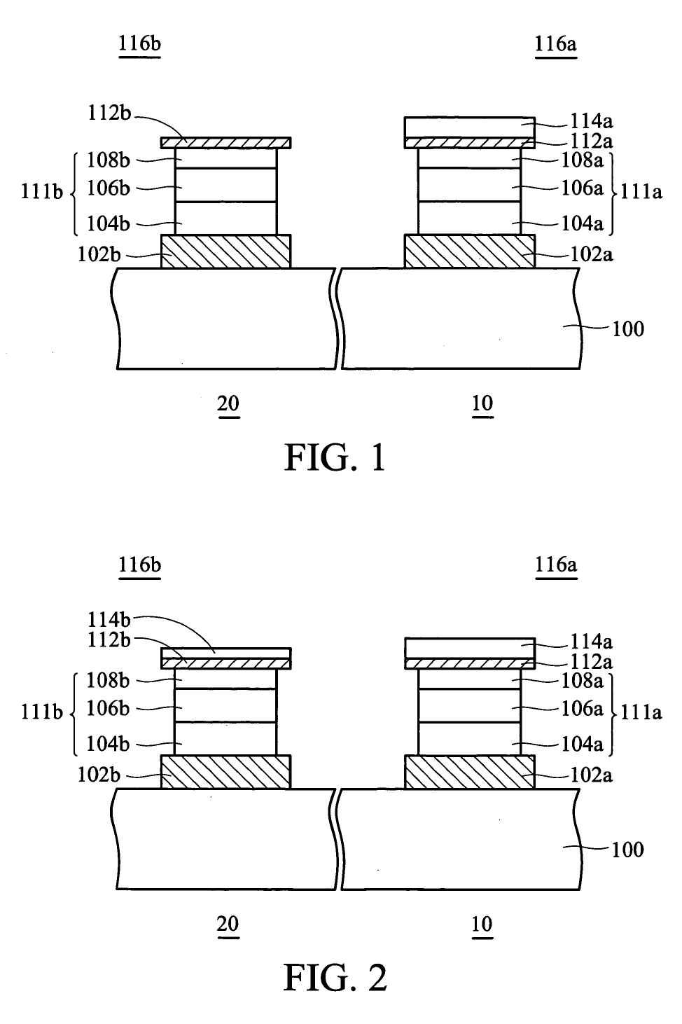

Organic electro-luminescent devices and methods for fabricating the same will be described in greater detail in the following. FIG. 1 is a cross-section of an embodiment of a method for fabricating a top emission type organic electro-luminescent device for a flat panel display. A substrate 100, such as a glass, quartz, silicon, or plastic substrate, comprising a plurality of device regions to form organic electro-luminescent diodes (OELDs) therein, is provided. Here, in order to simplify the diagram, only a first device region 10 and a second device region 20 are depicted. The first and second device regions 10 and 20 are employed to form organic electro-luminescent diodes therein for displaying different colors. For example, a red light organic electro-luminescent diode is formed in the first device region 10 and a blue light organic electro-luminescent diode in the second device region 20.

Anodes 102a and 102b are respectively formed in the first and second device regions 10 and 20 by conventional deposition. Anodes 102a and 102b can be a single conductive layer or a conductive stack structure. Typically, the anode may comprise indium tin oxide (ITO) or aluminum. In some embodiments, anodes 102a and 102b are a stack structure comprising an ITO (transparent) layer and an overlying aluminum (opaque) layer serving as a reflective layer. A hole injection layer (not shown), such as a copper phthalocyanine (CuPc) layer, is formed on each of anodes 102a and 102b.

Organic electro-luminescent medium layers 111a and 111b are respectively formed on the anodes 102a and 102b having a hole injection layer. The organic electro-luminescent medium layer 111a may be a stack structure comprising a transport layer 104a, a light-emitting layer 106a, and an electron transport layer 108a. The organic electro-luminescent medium layer 111b may also be a stack structure comprising a transport layer 104b, a light-emitting layer 106b, and an electron transport layer 108b. The organic electro-luminescent medium layers 111a and 111b may be formed by chemical vapor deposition (CVD) or thermal evaporation. The hole transport layers 104a and 104b may comprise naphtha-phenylbenzidene (NPB). The light-emitting layers 106a and 106b may comprise doped tris aluminum 8-hydroxy quinoline (Alq₃) . The electron transport layers 108a and 108b may also comprise Alq₃.

An electron injection layer (not shown), such as a LiF layer, is formed on each of the organic electro-luminescent medium layers 111a and 111b. Transparent cathodes 112a and 112b are respectively formed on the organic electro-luminescent medium layers 111a and 111b having an electron injection layer thereon. The transparent cathodes 112a and 112b may comprise ITO or indium zinc oxide (IZO) and be formed by sputtering. After the transparent cathodes 112a and 112b are formed, the fabrication of red and blue light organic electro-luminescent diodes 116a and 116b in the first and second device regions 10 and 20, respectively, is complete.

As mentioned, since the wavelength difference between blue light and red light is larger than that between green light and blue or red light, cathodes with different thicknesses are required. Typically, the transparent cathode of the blue light organic electro-luminescent diode has a thickness less than that of the red light electro-luminescent diode. For example, the transparent cathode of the blue light organic electro-luminescent diode has a thickness of about 300 to 450 Å and that of red light electro-luminescent diode about 700 to 800 Å. In some embodiments, in order to prevent the metal mask for forming the transparent cathode from deforming during sputtering, thinner transparent cathodes 112a and 112b are formed on the organic electro-luminescent medium layers 111a and 111b. For example, the transparent cathodes 112a and 112b have a thickness of about 300 to 450 Å. Thereafter, an optical layer 114 is formed on the transparent cathode 112a in the first device region 10 to compensate for the thickness of the transparent cathode 112a of the red light organic electro-luminescent diode 116a (a critical step of the embodiment). The optical layer 114a has a thickness of about 150 to 250 Å. Moreover, the optical layer 114a can be formed by E-beam deposition, thermal evaporation, molecular beam epitaxy (MBE), vapor phase epitaxy (VPE), or metal organic chemical vapor deposition (MOCVD). The transmittance of the optical layer 114a for visible light may be greater than 40%. For example, the optical layer 114a may comprise AlF₃, AlOₓN_{y}, BaF₂, BeO, Bi₂O₃, BiF₃, CaF₂, CdSe, CdS, CdTe, CeF₃, CeF₃, CeO₂, CsI, Gd₂O₃, HfO₂, HoF₃, Ho₂O₃, In₂O₃, LaF₃, La₂O₃, LiF, MgF₂, MgO, NaF, Na₃AlF₆, Na₅Al₃F₁₄, Nb₂O₅, NdF₃, Nd₂O₃, PbCl₂, PbF₂, PbTe, Pr₆O₁₁, Sb₂O₃, SiₓN_{y}, SiOₓ, SnO₂, Ta₂O₅, TeO₂, TiN, TiO₂, TiCl, ThF₄, V₂O₅, WO₃, YF₃, Y₂O₃, YbF₃, Yb₂O₃, ZnO, ZnS, ZnSe, ZrO₂ or alloys thereof. Preferably, the refraction index of the optical layer 114a is not less than 2. Since the deposition temperature of the optical layer 114a using the mentioned methods is below 70° C., the deformation of the metal mask can be avoided.

Also, FIG. 1 illustrates an embodiment of an organic electro-luminescent device with an optical compensation layer. The device comprises a substrate 100 and diodes 116a and 116. The substrate 100 comprises a first device region 10 and a second device region 20, wherein the diode 116a is disposed in the first device region 10 and another diode 116b in the second device region 20. The diode 116a employed for displaying red light, comprises an anode 102a and an opposing transparent cathode 112a, an organic electro-luminescent medium layer 111a disposed between the anode 102a and the transparent cathode 112a, and an optical layer 114a disposed on the transparent cathode 112a. The diode 116b is employed for displaying blue light, comprising an anode 102b and an opposing transparent cathode 112b, and an organic electro-luminescent medium layer 111b disposed between the anode 102b and the transparent cathode 112b. The transparent cathode 112a has a thickness of about 300 to 450 Å and substantially equal to the transparent cathode 112b.

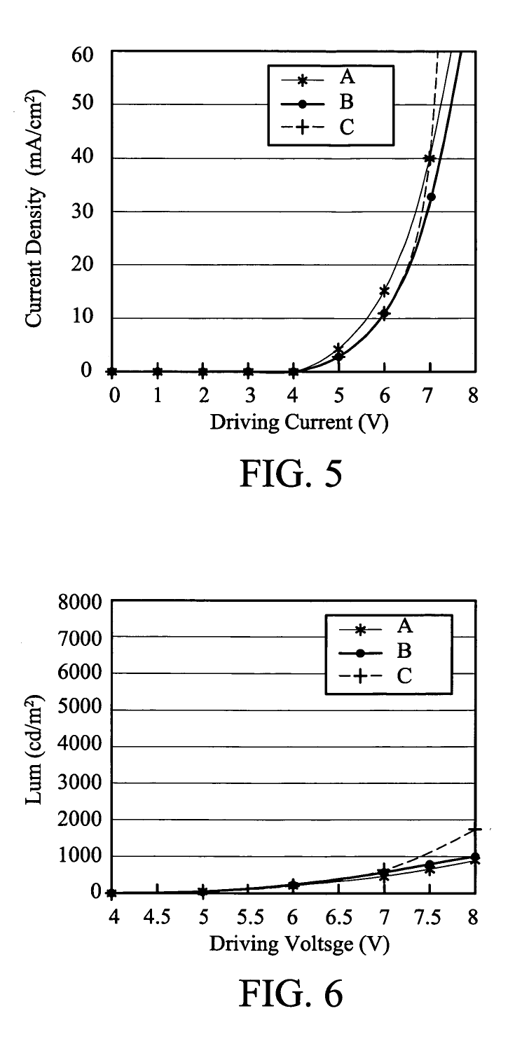

FIG. 5 illustrates a graph showing the relationship between the current density (mA/cm²) and the driving voltage (volt) for an organic electro-luminescent diode, wherein the curves A and C depict a red light organic electro-luminescent diode having a transparent cathode with a thickness of about 350 Å and 750 Å, respectively, and the curve B having a transparent cathode with a thickness of about 350 Å and an optical layer with a thickness of about 200 Å. As shown in FIG. 5, the current density of the curve B (using the optical layer to compensate the thickness of the transparent cathode of the organic electro-luminescent diode) is substantially equal to the curves A and C.

FIG. 6 illustrates a graph showing the relationship between the brightness (cd/m²) and the driving voltage (volt) for an organic electro-luminescent diode, wherein the curves A and C depict a red light organic electro-luminescent diode having a transparent cathode with a thickness of about 350 Å and 750 Å, respectively, and the curve B having a transparent cathode with a thickness of about 350 Å and an optical layer with a thickness of about 200 Å. As shown in FIG. 6, the brightness of the curve B (using the optical layer to compensate the thickness of the transparent cathode of the organic electro-luminescent diode) is substantially equal to the curves A and C.

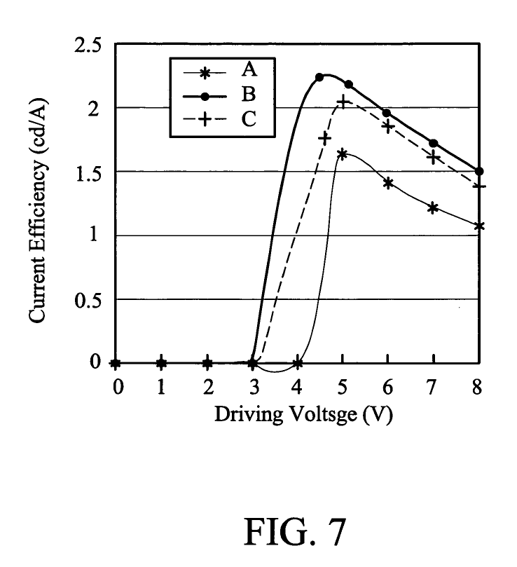

FIG. 7 illustrates a graph showing the relationship between the current efficiency (cd/A) and the driving voltage (volt) for an organic electro-luminescent diode, wherein the curves A and C depict a red light organic electro-luminescent diode having a transparent cathode with a thickness of about 350 Å and 750 Å, respectively, and the curve B having a transparent cathode with a thickness of about 350 Å and an optical layer with a thickness of about 200 Å. As shown in FIG. 7, the current efficiency of the curve B (using the optical layer to compensate the thickness of the transparent cathode of the organic electro-luminescent diode) is higher than the curve C (insufficient transparent cathode thickness) and approximate to the curve A. According to the embodiment of the organic electro-luminescent device (curve B), the deformation of the metal mask can be avoided, thereby increasing reliability of devices. Moreover, compared with the curve C, the current efficiency can be increased.

FIG. 2 illustrates an embodiment of an organic electro-luminescent device with an optical compensation layer, wherein the same reference numbers as FIG. 1 are used in the drawing and the description of the same or like parts is omitted. In the embodiment of FIG. 1, the transparent cathode 112a has a thickness substantially equal to a desired thickness for the transparent cathode 112b of the blue light organic electro-luminescent diode 116b. For example, the desired thickness for the transparent cathode 112b is about 300 to 450 Å. In this embodiment, the thickness of the transparent cathodes 112a and 112b may be reduced. Thereafter, an optical layer 114a is formed on the transparent cathode 112a in the first device region 10 and an additional optical layer 114b is formed on the transparent cathode 112b in the second device region 20. Note that the optical layer 114b is employed to compensate the thickness of the transparent cathode 112b, having a thickness different from the optical layer 114a. The thickness of the optical layer 114b may be adjusted according to the demands of the blue light organic electro-luminescent diode 116b as well as the optical layer 114a. Moreover, the transmittance of the optical layer 114b for visible light is greater than 40% and the optical layer 114b may comprise the same material as the optical layer 114a or not.

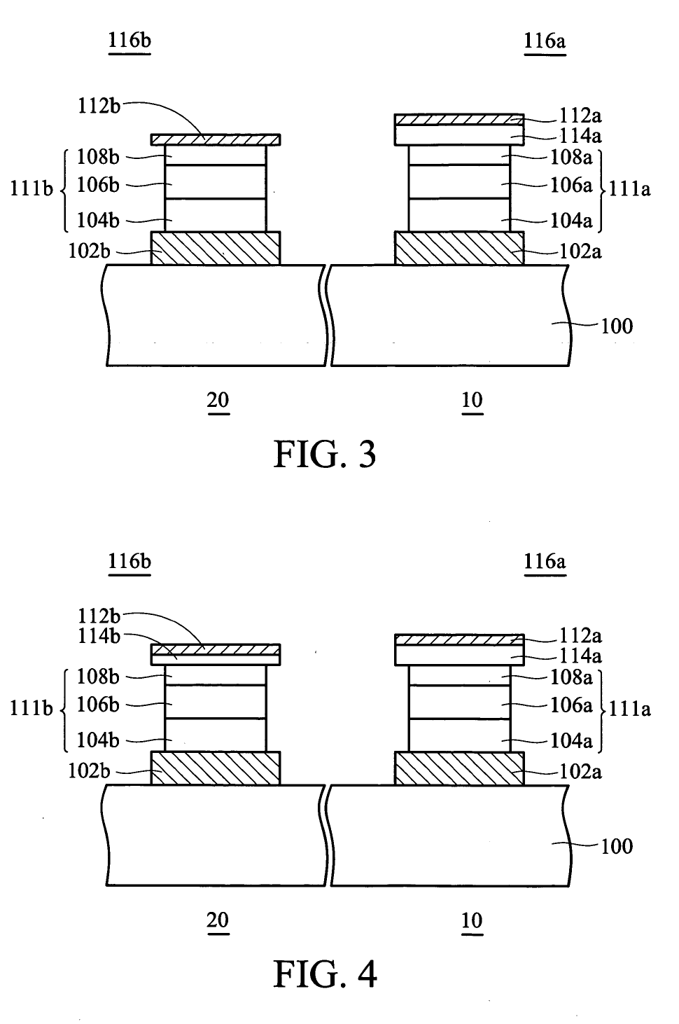

FIG. 3 illustrates an embodiment of an organic electro-luminescent device with an optical compensation layer, wherein the same reference numbers as FIG. 1 are used in the drawing and the description of the same or like parts is omitted. In the embodiment of FIG. 1, the optical layer 114a serving as an optical compensation layer is formed on the transparent cathode 112a. In this embodiment, the optical layer 114a may be formed on the organic electro-luminescent medium layer 111a in the first device region 10 after forming the electron injection layer (not shown). Thereafter, a transparent cathode 112a is formed on the optical layer 114a in the first device region 10 and a transparent cathode 112b simultaneously formed on the organic electro-luminescent medium layer 111b with an electron injection layer thereon in the second device region 20.

FIG. 4 illustrates an embodiment of an organic electro-luminescent device with an optical compensation layer, wherein the same reference numbers as FIG. 2 are used in the drawing and the description of the same or like parts is omitted. In the embodiment of FIG. 2, the optical layers 114a and 114b with different thicknesses are respectively formed on the transparent cathode 112a in the first device region 10 and on the transparent cathode 112b in the second device region 20. In this embodiment, the optical layers 114a and 114b with different thicknesses are respectively formed on the organic electro-luminescent medium layers 111a and 111b having an electron injection layer thereon prior to the formation of the transparent cathodes 112a and 112b.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An organic electro-luminescent device, comprising:
a substrate comprising a first device region and a second device region;
a first anode and an opposing first transparent cathode disposed in the first device region;
a first organic electro-luminescent medium layer sandwiched between the first anode and the first transparent cathode;
a first optical layer adjacent to the first transparent cathode;
a second anode and an opposing second transparent cathode disposed in the second device region; and
a second organic electro-luminescent medium layer sandwiched between the second anode and the second transparent cathode;
wherein the first transparent cathode has a thickness substantially equal to the second transparent cathode.

2. The device as claimed in claim 1, wherein the first optical layer is disposed on the first transparent cathode.

3. The device as claimed in claim 2, further comprising a second optical layer disposed on the second transparent cathode, having a thickness different from that of first optical layer.

4. The device as claimed in claim 1, wherein the first optical layer is sandwiched between the first transparent cathode and the first organic electro-luminescent medium layer.

5. The device as claimed in claim 4, further comprising a second optical layer sandwiched between the second transparent cathode and the second organic electro-luminescent medium layer, having a thickness different from that of first optical layer.

6. The device as claimed in claim 1, wherein the transmittance of the first optical layer for visible light is greater than 40%.

7. The device as claimed in claim 1, wherein the refraction index of the first optical layer is great than or equal to 2.

8. The device as claimed in claim 1, wherein the first transparent cathode has a thickness of 5 to 1000 Å.

9. The device as claimed in claim 8, wherein the first optical layer has a thickness of 5 to 1000 Å.

10. The device as claimed in claim 1, wherein the first and second anodes further comprise an opaque layer serving as a reflective layer.

11. A method for fabricating an electro-luminescent device, comprising:
providing a substrate comprising a first device region and a second device region;
respectively forming an anode in the first and second device regions;
forming an organic electro-luminescent medium layer on each anode;
forming a transparent cathode on each organic electro-luminescent medium layer; and
forming a first optical layer adjacent to the transparent cathode in the first device region.

12. The method as claimed in claim 11, wherein the first optical layer is formed on the transparent cathode in the first device region.

13. The method as claimed in claim 12, further forming a second optical layer on the transparent cathode in the second device region, having a thickness different from that of the first optical layer.

14. The method as claimed in claim 11, wherein the first optical layer is formed between the transparent cathode and the organic electro-luminescent medium layer in the first device region.

15. The method as claimed in claim 14, further forming a second optical layer between the transparent cathode and the organic electro-luminescent medium layer in the second device region, having a thickness different from that of the first optical layer.

16. The method as claimed in claim 11, wherein the transmittance of the first optical layer for visible light is greater than 40%.

17. The method as claimed in claim 11, wherein the refraction index of the first optical layer is great than or equal to 2.

18. The method as claimed in claim 11, wherein the anode further comprise an opaque layer serving as a reflective layer.

19. The method as claimed in claim 11, wherein the first optical layer is formed at a temperature below 70° C.

20. The method as claimed in claim 11, wherein the first optical layer is formed by E-beam deposition, thermal evaporation, molecular beam epitaxy, vapor phase epitaxy, or metal organic chemical vapor deposition.
